(19) United States
(12) Patent Application Publication
(10) Pub. No.: US 2014/0329146 A1
(43) Pub. Date: Nov. 6, 2014

(54) NONAQUEOUS ELECTROLYTE SECONDARY BATTERY

(71) Applicants: Fumiharu Niina, Hyogo (JP); Hiroshi Kawada, Hyogo (JP); Toshikazu Yoshida, Hyogo (JP); Yoshinori Kida, Hyogo (JP)

(72) Inventors: Fumiharu Niina, Hyogo (JP); Hiroshi Kawada, Hyogo (JP); Toshikazu Yoshida, Hyogo (JP); Yoshinori Kida, Hyogo (JP)

(73) Assignee: SANYO ELECTRIC CO., LTD., Moriguchi-shi, Osaka (JP)

(21) Appl. No.: 14/131,771

(22) PCT Filed: Jun. 29, 2012
(86) PCT No.: PCT/JP2012/066663

§ 371 Date: Feb. 4, 2014

(30) Foreign Application Priority Data
Jul. 28, 2011 (JP) 2011-165835
Feb. 29, 2012 (JP) 2012-044493

(51) Int. Cl. H01M 4/131

(52) U.S. Cl. CPC H01M 4/131; H01M 2004/028
USPC 429/223

(57) ABSTRACT

A positive-electrode active material of a nonaqueous electrolyte secondary battery is modified to improve the output characteristics under various temperature conditions, thereby making the nonaqueous electrolyte secondary battery suitable for a power supply for hybrid vehicles. The nonaqueous electrolyte secondary battery includes a working electrode 11, a counter electrode 12 containing a negative-electrode active material, and a nonaqueous electrolyte solution 14. In the working electrode 11, a positive-electrode mixture layer containing a granular positive-electrode active material and a binder is disposed on both sides of a positive-electrode collector. The positive-electrode active material contains a lithium transition metal oxide Li_{1.07}Ni_{0.46}Co_{0.19}Mn_{0.28}O₂ and a tungsten trioxide attached to part of the surface of the lithium transition metal oxide.

### TECHNICAL FIELD

The present invention relates to a nonaqueous electrolyte secondary battery.

### BACKGROUND ART

Mobile devices, such as mobile phones, notebook computers, and smartphones, are becoming smaller and lighter and are consuming more power because of increased functionality. Thus, there is a growing demand for lighter and higher-capacity nonaqueous electrolyte secondary batteries for use as power supplies for these devices. Furthermore, in order to solve the recent environmental issues caused by automotive exhaust gases, hybrid electric vehicles that include an automobile gasoline engine and an electric motor in combination are being developed.

Although nickel-hydrogen storage batteries are generally widely used as power supplies for such electric vehicles, use of nonaqueous electrolyte secondary batteries as higher-capacity and higher-output power supplies is under study. However, existing nonaqueous electrolyte secondary batteries have poor output characteristics because lithium transition metal oxides used as the positive-electrode active materials of the batteries have low electrical conductivity.

The following positive-electrode active materials (1) and (2) are proposed to increase the electrical conductivity of lithium transition metal oxides in the positive-electrode active materials.

(1) A positive-electrode active material containing spinel manganese oxide having a surface modified with tungsten oxide (see Patent Literature 1).

(2) A positive-electrode active material containing a lithium transition metal oxide having a layer structure containing nickel, cobalt, and manganese, the surface of the lithium transition metal oxide being covered with a low-valent oxide (see Patent Literature 2).

### CITATION LIST

### Patent Literature

PTL 1: Japanese Published Unexamined Patent Application No. 2005-320184

PTL 2: Japanese Published Unexamined Patent Application No. 2007-188699

### SUMMARY OF INVENTION

### Technical Problem

However, the proposition (1) has an insufficient effect of improving discharging characteristics. The proposition (2) also had an insufficient effect of improving discharging characteristics. Thus, existing nonaqueous electrolyte secondary batteries cannot be suitably used as power supplies for hybrid electric vehicles.

### Solution to Problem

A nonaqueous electrolyte secondary battery according to one aspect of the present invention includes a positive electrode containing a positive-electrode active material, the positive-electrode active material containing a lithium transition metal oxide and a tungsten compound and/or a molybdenum compound attached to part of the surface of the lithium transition metal oxide, the lithium transition metal oxide containing nickel as a main component of the transition metal, a negative electrode containing a negative-electrode active material, a separator disposed between the positive electrode and the negative electrode, and a nonaqueous electrolyte solution with which the separator is impregnated.

### Advantageous Effects of Invention

The present invention has excellent advantageous effects, such as improvement in output characteristics under various temperature conditions.

### BRIEF DESCRIPTION OF DRAWINGS

FIG. 1 is a schematic explanatory view of a three-electrode test cell according to an embodiment of the present invention.

### DESCRIPTION OF EMBODIMENTS

A nonaqueous electrolyte secondary battery according to one embodiment of the present invention includes a positive electrode containing a positive-electrode active material, the positive-electrode active material containing a lithium transition metal oxide and a tungsten compound and/or a molybdenum compound attached to part of the surface of the lithium transition metal oxide, the lithium transition metal oxide containing nickel as a main component of the transition metal, a negative electrode containing a negative-electrode active material, a separator disposed between the positive electrode and the negative electrode, and a nonaqueous electrolyte solution with which the separator is impregnated.

Use of the positive-electrode active material containing a tungsten compound and/or a molybdenum compound attached to part of the surface of the lithium transition metal oxide allows the tungsten compound and/or the molybdenum compound to react with residual lithium (a resistance component) disposed on the surface of the lithium transition metal oxide and reduce the reaction resistance on the surface of the lithium transition metal oxide. This promotes a charge transfer reaction at the interface between the lithium transition metal oxide and the electrolyte solution and improves the output characteristics under various temperature conditions.

The term “attached to”, as used herein, means that the tungsten compound and/or the molybdenum compound is simply attached to the surface of the lithium transition metal oxide and excludes the diffusion of the tungsten compound and/or the molybdenum compound in the lithium transition metal oxide (or the diffusion of tungsten and/or molybdenum in the lithium transition metal oxide) after heat treatment of the lithium transition metal oxide in the presence of the tungsten compound and/or the molybdenum compound. This is because the heat treatment of the lithium transition metal oxide in the presence of the tungsten compound and/or the molybdenum compound reproduces a resistance component lithium on the surface of the lithium transition metal oxide and therefore cannot promote the charge transfer reaction and cannot improve the output characteristics.

A niobium compound or a titanium compound, instead of the tungsten compound and/or the molybdenum compound, attached to the surface of the lithium transition metal oxide does not react with residual lithium on the surface of the lithium transition metal oxide. Thus, the niobium compound or the titanium compound does not reduce the reaction resistance on the surface of the lithium transition metal oxide and has no effect of improving the output characteristics. The effect of improving the output characteristics is therefore a specific effect that is produced only when the tungsten compound and/or the molybdenum compound is attached to the surface of the lithium transition metal oxide.

The lithium transition metal oxide may be any lithium transition metal oxide that contains nickel as a main component of the transition metal. Such a structure can increase the power and capacity of the battery. The sentence “a main component of the transition metal is nickel”, as used herein, means that the nickel content (number of moles) of the lithium transition metal oxide is highest among the transition metals of the lithium transition metal oxide.

The reason that the lithium transition metal oxide is limited to the lithium transition metal oxide containing nickel as a main component of the transition metal is that lithium transition metal oxides not containing nickel as a main component of the transition metal, such as LiCoO₂, LiFePO₄, LiMn₂O₄, LiNi_{0.4}Co_{0.6}O₂, and LiNi_{0.4}Mn_{0.6}O₂, contain little residual lithium on their surfaces, and a tungsten compound or a molybdenum compound attached to part of the surface of such lithium transition metal oxides cannot improve the output characteristics.

As described below, from the perspective of the output characteristics (in particular, low-temperature output characteristics) associated with the attachment of a tungsten compound or a molybdenum compound, it is desirable that the transition metal contain manganese and/or cobalt in addition to nickel. In particular, transition metals containing manganese and cobalt are preferred because such transition metals have the highest effect of improving the output characteristics.

It is desirable that the lithium transition metal oxide be an oxide having the general formula Liᵢ₊ₓNiₐMn_{b}Co_{c}O_{2+d} (wherein x, a, b, c, and d satisfy x+a+b+c=1, 0<x≦0.1, a≧b, a≧c, 0<c/(a+b)<0.65, 1.0≦a/b≦3.0, and −0.1≦d≦0.1).

The reason that the Co component ratio c, the Ni component ratio a, and the Mn component ratio b of the lithium nickel cobalt manganese oxide having the general formula satisfy 0<c/(a+b)<0.65 is that the Co content is decreased to reduce the material cost of the positive-electrode active material.

The reason that the Ni component ratio a and the Mn component ratio b of the lithium nickel cobalt manganese oxide having the general formula satisfy 1.0≦a/b≦3.0 is that a high Ni content corresponding to a/b of more than 3.0 results in poor thermal stability of the lithium nickel cobalt manganese oxide and a low exothermic peak temperature, which are unfavorable for battery design to ensure the safety of the battery. A high Mn content corresponding to a/b of less than 1.0 tends to result in the formation of an impurity layer and low capacity. In consideration of such situations, 1.0≦a/b≦2.0, particularly 1.0≦a/b≦1.8, is further preferred.

The reason that x of the Li component ratio (1+x) of the lithium nickel cobalt manganese oxide having the general formula satisfies 0<x≦0.1 is that satisfying the condition of 0<x results in improved output characteristics, and x>0.1 results in an increased amount of residual alkali on the surface of the lithium nickel cobalt manganese oxide, which increases the likelihood of the gelation of slurry in the battery manufacturing process, reduces the amount of transition metal involved in an oxidation-reduction reaction, and reduces the positive electrode capacity. In consideration of such situations, 0.05≦x≦0.1, particularly 0.07≦x≦0.1, is further preferred.

The reason that d of the 0 component ratio (2+d) of the lithium nickel cobalt manganese oxide having the general formula satisfies −0.1≦d≦0.1 is that this prevents the crystal structure of the lithium nickel cobalt manganese oxide from being damaged by the oxygen deficiency condition or the oxygen excess condition of the lithium nickel cobalt manganese oxide.

The lithium nickel cobalt manganese oxide having the general formula particularly preferably satisfies a>b, a>c, and 1.0<a/b≦3.0 (in particular, 1.0<a/b≦2.0, among others, 1.0<a/b≦1.8).

It is desirable that the tungsten compound be a tungsten-containing oxide, and the molybdenum compound be a molybdenum-containing oxide. This is because such an oxide can prevent the inclusion of impurities other than lithium, tungsten, and molybdenum in the positive-electrode active material. Examples of the tungsten-containing oxide include tungsten oxide and lithium tungstate. Among others, WO₃ and Li₂WO₄ are more preferred because hexavalent tungsten in these tungsten compounds is most stable. Examples of the molybdenum-containing oxide include molybdenum oxide and lithium molybdate. Among others, MoO₃ and Li₂MoO₄ are more preferred because hexavalent molybdenum in these molybdenum compounds is most stable.

It is desirable that the lithium transition metal oxide has a volume-average primary particle size of 0.5 μm or more and 2 μm or less and a volume-average secondary particle size of 3 μm or more and 20 μm or less. This is because excessively large lithium transition metal oxide particles impair discharge performance, and excessively small lithium transition metal oxide particles have high reactivity with the nonaqueous electrolyte solution and impair storage characteristics.

The volume-average particle size of the primary particles was determined by direct observation with a scanning electron microscope (SEM). The volume-average particle size of the secondary particles was determined using a laser diffraction method.

### (Others)

(1) The lithium transition metal oxide may be produced by any method. For example, the lithium transition metal oxide may be produced by firing raw materials composed of a lithium compound and a complex hydroxide of the transition metal or a complex oxide of the transition metal at an appropriate temperature. The lithium compound is not particularly limited. For example, the lithium compound may be one or two or more selected from the group consisting of lithium hydroxide, lithium carbonate, lithium chloride, lithium sulfate, lithium acetate, and hydrates thereof. The firing temperature of the raw materials depends on the composition and the particle size of the complex hydroxide of the transition metal or the complex oxide of the transition metal and is difficult to fix. In general, the firing temperature of the raw materials ranges from 500° C. to 1100° C., preferably 600° C. to 1000° C., more preferably 700° C. to 900° C.

The method for producing the positive-electrode active material by attaching the tungsten compound and/or the molybdenum compound to the surface of the lithium transition metal oxide is not limited to a method of mixing the lithium transition metal oxide with a predetermined amount of the tungsten compound or the molybdenum compound and may be a mechanical method, such as a Mechanofusion process (Hosokawa Micron Corp.).

(2) In addition to nickel (Ni), the lithium transition metal oxide may further contain manganese (Mn) and/or cobalt (Co) and/or at least one selected from the group consisting of boron (B), fluorine (F), magnesium (Mg), aluminum (Al), titanium (Ti), chromium (Cr), vanadium (V), iron (Fe), copper (Cu), zinc (Zn), niobium (Nb), molybdenum (Mo), tantalum (Ta), zirconium (Zr), tin (Sn), tungsten (W), sodium (Na), potassium (K), barium (Ba), strontium (Sr), and calcium (Ca).

(3) After the production of the lithium transition metal oxide, a compound containing boron (B), fluorine (F), magnesium (Mg), aluminum (Al), titanium (Ti), chromium (Cr), vanadium (V), iron (Fe), copper (Cu), zinc (Zn), niobium (Nb), tantalum (Ta), zirconium (Zr), tin (Sn), barium (Ba), strontium (Sr), and/or calcium (Ca) may be added to the lithium transition metal oxide and then may be fired at a temperature lower than the firing temperature employed in the production of the lithium transition metal oxide to sinter the compound on the surface of the lithium transition metal oxide. The specific firing temperature ranges from 400° C. to 1000° C., preferably 500° C. to 900° C.

(4) The tungsten compound is not limited to tungsten oxide or lithium tungstate described above and may be sodium tungstate, potassium tungstate, barium tungstate, calcium tungstate, magnesium tungstate, cobalt tungstate, tungsten bromide, tungsten chloride, tungsten boride, or tungsten carbide. These tungsten compounds may be used in combination.

(5) The molybdenum compound is not limited to molybdenum oxide or lithium molybdate described above and may be sodium molybdate, potassium molybdate, barium molybdate, calcium molybdate, magnesium molybdate, cobalt molybdate, molybdenum bromide, molybdenum chloride, molybdenum boride, or molybdenum carbide. These molybdenum compounds may be used in combination. The molybdenum compound and the tungsten compound may be used in combination.

(6) An excessively small amount of the tungsten compound and/or the molybdenum compound may reduce the operational advantage of the tungsten compound and/or the molybdenum compound. An excessively large amount of the tungsten compound and/or the molybdenum compound results in poor charge-discharge characteristics of the battery because the surface of the lithium transition metal oxide is widely covered with the tungsten compound and/or the molybdenum compound (an excessively large covered area). In consideration of such situations, the amount of tungsten compound in the positive-electrode active material represented by the tungsten compound/(tungsten compound+lithium transition metal oxide) ratio is preferably 0.05 mol % or more and 10.00 mol % or less, 0.10 mol % or more and 5.00 mol % or less in particular, 0.20 mol % or more and 1.5 mol % or less among others. Likewise, the amount of molybdenum compound in the positive-electrode active material is preferably 0.05 mol % or more and 10.00 mol % or less, 0.10 mol % or more and 5.00 mol % or less in particular, 0.20 mol % or more and 1.5 mol % or less among others.

(7) The use of the positive-electrode active material is not limited to the simple use of the positive-electrode active material that contains the tungsten compound and/or the molybdenum compound attached to the surface of the lithium transition metal oxide and may be the combined use of the positive-electrode active material and another positive-electrode active material. That other positive-electrode active material may be any compound that can reversibly intercalate and deintercalate lithium and may be a compound having a layer structure, a spinel structure, or an olivine structure that can intercalate and deintercalate lithium while retaining its stable crystal structure.

(8) The negative-electrode active material may be any material that can reversibly absorb and release lithium and may be a carbon material, a metal that can form an alloy with lithium, an alloy material, or a metal oxide. The negative-electrode active material is preferably a carbon material in terms of the material cost and may be natural graphite, artificial graphite, mesophase pitch carbon fibers (MCF), mesocarbon microbeads (MCMB), coke, hard carbon, fullerene, or carbon nanotubes. In particular, in order to improve high-rate charge-discharge characteristics, the negative-electrode active material is preferably a graphite material covered with low-crystallinity carbon.

(9) A nonaqueous solvent for use in the nonaqueous electrolyte solution may be a known nonaqueous solvent generally used in nonaqueous electrolyte secondary batteries. Examples of such a nonaqueous solvent include cyclic carbonates, such as ethylene carbonate, propylene carbonate, butylene carbonate, and vinylene carbonate, and linear carbonates, such as dimethyl carbonate, methyl ethyl carbonate, and diethyl carbonate. In particular, a mixed solvent of a cyclic carbonate and a linear carbonate is preferably used as a nonaqueous solvent having a low viscosity, a low melting point, and a high lithium ion conductivity. The volume ratio of the cyclic carbonate to the linear carbonate of such a mixed solvent preferably ranges from 2:8 to 5:5.

The nonaqueous solvent of the nonaqueous electrolyte solution may also be an ionic liquid. In this case, the cationic species and the anionic species are not particularly limited. In terms of low viscosity, electrochemical stability, and hydrophobicity, the cation is particularly preferably a pyridinium cation, an imidazolium cation, or a quaternary ammonium cation, and the anion is particularly preferably a fluorine-containing imide anion.

(10) A solute for use in the nonaqueous electrolyte solution may be a known lithium salt generally used in nonaqueous electrolyte secondary batteries. Examples of such a lithium salt include lithium salts containing at least one element of P, B, F, O, S, N, and Cl, such as LiPF₆, LiBF₄, LiCF₃SO₃, LiN(FSO₂)₂, LiN(CF₃SO₂)₂, LiN(C₂F₅SO₂)₂, LiN(CF₃SO₂) (C₄F₉SO₂), LiC(C₂F₅SO₂)₃, LiAsF₆, LiClO₄, and mixtures thereof. In particular, LiPF₆ is preferred in order to improve the high-rate charge-discharge characteristics and durability of the nonaqueous electrolyte secondary battery.

The solute of the nonaqueous electrolyte solution may also be a lithium salt containing an oxalato complex as an anion. The lithium salt containing an oxalato complex as an anion may be LiBOB [lithium bisoxalate borate] or a lithium salt containing an anion having C₂O₄²⁻ coordinated with the central atom, for example, Li[M(C₂O₄)ₓR_{y}] (wherein M denotes a transition metal, an element selected from groups IIIb, IVb, and Vb of the periodic table, R denotes a group selected from halogen, alkyl groups, and halogen-substituted alkyl groups, x denotes a positive integer, and y denotes 0 or a positive integer). Specific example may be Li[B(C₂O₄) F₂], Li[P(C₂O₄) F₄], or Li[P(C₂O₄)₂F₂]. LiBOB is most preferred in order to form a stable film on the surface of the negative electrode even in a high-temperature environment.

(11) The separator disposed between the positive electrode and the negative electrode may be made of any material that can prevent a short circuit caused by the contact between the positive electrode and the negative electrode and can be impregnated with a nonaqueous electrolyte solution and thereby have lithium ion conductivity. For example, the separator may be a polypropylene separator, a polyethylene separator, or a polypropylene-polyethylene multilayer separator.

### EXAMPLES

A nonaqueous electrolyte secondary battery according to the present invention will be more specifically described. A nonaqueous electrolyte secondary battery according to the present invention is not limited to the following examples and may be modified without departing from the gist of the present invention.

### Example 1

First, Li₂Co₃ and Ni_{0.5}Co_{0.2}Mn_{0.3}(OH)₂ produced by a coprecipitation method were mixed at a predetermined ratio and were fired in the air at 900° C. for 10 hours to form lithium transition metal oxide particles of Li_{1.07}Ni_{0.46}Co_{0.19}Mn_{0.28}O₂ having a layer structure. The lithium transition metal oxide particles thus formed had a volume-average primary particle size of approximately 1 μm and a volume-average secondary particle size of approximately 8 μm.

The lithium transition metal oxide particles of Li_{1.07}Ni_{0.46}Co_{0.19}Mn_{0.28}O₂ and tungsten trioxide (WO₃) having an average particle size of 150 nm were then mixed at a predetermined ratio to yield a positive-electrode active material containing WO₃ attached to part of the surface of the lithium transition metal oxide particles. The WO₃ content of the positive-electrode active material thus produced was 1.0 mol %.

The positive-electrode active material, vapor-grown carbon fibers (VGCF) serving as an electrically conductive agent, and a poly(vinylidene fluoride) binder dissolved in N-methyl-2-pyrrolidone were then weighed at a mass ratio of 92:5:3 and were mixed to prepare a positive-electrode mixture slurry. Subsequently, the positive-electrode mixture slurry was applied to both sides of a positive-electrode collector formed of aluminum foil, was dried, and was rolled with a rolling roller. An aluminum positive-electrode collector tab was attached to the positive-electrode collector to produce a positive electrode.

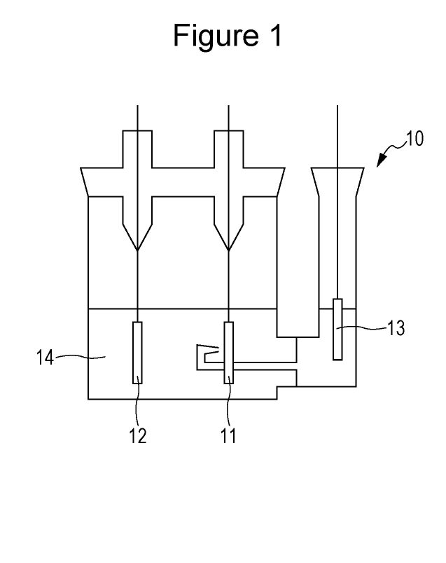

As illustrated in FIG. 1, the positive electrode thus produced was used as a working electrode 11. Metallic lithium was used for a counter electrode 12 serving as a negative electrode and a reference electrode 13. A nonaqueous electrolyte solution 14 was prepared by dissolving 1 mol/l of LiPF₆ in a mixed solvent of ethylene carbonate, methyl ethyl carbonate, and dimethyl carbonate mixed at a volume ratio of 3:3:4 and dissolving 1% by mass vinylene carbonate in the mixed solvent. A three-electrode test cell 10 was assembled from the working electrode 11, the counter electrode 12, the reference electrode 13, and the nonaqueous electrolyte solution 14.

The test cell thus assembled is hereinafter referred to as a cell A1.

### Example 2

A test cell was assembled in the same manner as in Example 1 except that tungsten trioxide was substituted by tungsten dioxide (WO₂) and the positive-electrode active material contained WO₂ attached to part of the surface of the lithium transition metal oxide particles. The WO₂ content of the positive-electrode active material thus produced was 1.0 mol %.

The test cell thus assembled is hereinafter referred to as a cell A2.

### Example 3

A test cell was assembled in the same manner as in Example 1 except that tungsten trioxide was substituted by lithium tungstate (Li₂WO₄) and the positive-electrode active material contained Li₂WO₄ attached to part of the surface of the lithium transition metal oxide particles. The Li₂WO₄ content of the positive-electrode active material thus produced was 1.0 mol %.

The test cell thus assembled is hereinafter referred to as a cell A3.

### Example 4

A test cell was assembled in the same manner as in Example 1 except that the tungsten compound (WO₃) content of the positive-electrode active material was 0.1 mol %.

The test cell thus assembled is hereinafter referred to as a cell A4.

### Example 5

A test cell was assembled in the same manner as in Example 1 except that the lithium transition metal oxide particles were formed as described below.

Li₂Co₃ and Ni_{0.57}Co_{0.10}Mn_{0.37}(OH)₂ produced by a coprecipitation method were mixed at a predetermined ratio and were fired in the air at 930° C. for 10 hours to form lithium transition metal oxide particles of Li_{1.07}Ni_{0.53}Co_{0.10}Mn_{0.31}O₂ having a layer structure. The lithium transition metal oxide particles had a volume-average primary particle size of approximately 1 μm and a volume-average secondary particle size of approximately 8 μm. The WO₃ content of the positive-electrode active material was 1.0 mol %.

The test cell thus assembled is hereinafter referred to as a cell A5.

### Example 6

A test cell was assembled in the same manner as in Example 1 except that the positive-electrode active material was produced as described below.

Li₂Co₃ and Ni_{0.5}Co_{0.2}Mn_{0.3}(OH)₂ produced by a coprecipitation method were mixed at a predetermined ratio and were fired in the air at 930° C. for 10 hours to form lithium transition metal oxide particles of Li_{1.04}Ni_{0.48}Co_{0.19}Mn_{0.29}O₂ having a layer structure. The lithium transition metal oxide particles thus formed had a volume-average primary particle size of approximately 1 μm and a volume-average secondary particle size of approximately 13 μm.

The lithium transition metal oxide particles of Li_{1.04}Ni_{0.48}Co_{0.19}Mn_{0.29}O₂ and tungsten trioxide (WO₃) having an average particle size of 150 nm were then mixed at a predetermined ratio to yield a positive-electrode active material containing WO₃ attached to part of the surface of the lithium transition metal oxide particles. The WO₃ content of the positive-electrode active material thus produced was 10.0 mol %.

The test cell thus assembled is hereinafter referred to as a cell A6.

### Example 7

A test cell was assembled in the same manner as in Example 1 except that the positive-electrode active material was produced as described below.

Li₂Co₃ and Ni_{0.6}Mn_{0.4}(OH)₂ produced by a coprecipitation method were mixed at a predetermined ratio and were fired in the air at 1000° C. for 10 hours to form lithium transition metal oxide particles of Li_{1.06}Ni_{0.56}Mn_{0.38}O₂ having a layer structure. The lithium transition metal oxide particles thus formed had a volume-average primary particle size of approximately 1 μm and a volume-average secondary particle size of approximately 8 μm.

The lithium transition metal oxide particles of Li_{1.06}Ni_{0.56}Mn_{0.38}O₂ and tungsten trioxide (WO₃) having an average particle size of 150 nm were then mixed at a predetermined ratio to yield a positive-electrode active material containing WO₃ attached to part of the surface of the lithium transition metal oxide particles. The WO₃ content of the positive-electrode active material thus produced was 1.0 mol %.

The test cell thus assembled is hereinafter referred to as a cell A7.

### Example 8

A test cell was assembled in the same manner as in Example 1 except that the positive-electrode active material was produced as described below.

LiOH and Ni_{0.81}Co_{0.16}Al_{0.03}(OH)₂ produced by a coprecipitation method were mixed at a predetermined ratio and were fired in an oxygen atmosphere at 800° C. for 10 hours to form lithium transition metal oxide particles of Li_{1.02}Ni_{0.8}Co_{0.15}Al_{0.03}O₂ having a layer structure. The lithium transition metal oxide particles thus formed had a volume-average primary particle size of approximately 1 μm and a volume-average secondary particle size of approximately 12 μm.

The lithium transition metal oxide particles of Li_{1.02}Ni_{0.8}Co_{0.15}Al_{0.03}O₂ and tungsten trioxide (WO₃) having an average particle size of 150 nm were then mixed at a predetermined ratio to yield a positive-electrode active material containing WO₃ attached to part of the surface of the lithium transition metal oxide particles. The WO₃ content of the positive-electrode active material thus produced was 1.0 mol %.

The test cell thus assembled is hereinafter referred to as a cell A8.

### Example 9

A test cell was assembled in the same manner as in Example 1 except that tungsten trioxide was substituted by molybdenum trioxide (MoO₃) and the positive-electrode active material contained MoO₃ attached to part of the surface of the lithium transition metal oxide particles. The MoO₃ content of the positive-electrode active material thus produced was 1.0 mol %.

The test cell thus assembled is hereinafter referred to as a cell A9.

### Comparative Example 1

A test cell was assembled in the same manner as in Example 1 except that tungsten trioxide was not attached to part of the surface of the lithium transition metal oxide particles (thus, the positive-electrode active material was composed of the lithium transition metal oxide particles alone).

The test cell thus assembled is hereinafter referred to as a cell Z1.

### Comparative Example 2

A test cell was assembled in the same manner as in Example 1 except that lithium transition metal oxide particles and tungsten trioxide (WO₃) were mixed at a predetermined ratio and were fired in the air at 700° C. for one hour to yield a positive-electrode active material containing a tungsten compound sintered on the surface of the lithium transition metal oxide particles. The WO₃ content of the positive-electrode active material thus produced was 1.0 mol %.

The test cell thus assembled is hereinafter referred to as a cell Z2.

### Comparative Example 3

A test cell was assembled in the same manner as in Example 1 except that tungsten trioxide was substituted by diniobium pentoxide (Nb₂O₅) and the positive-electrode active material contained Nb₂O₅ attached to part of the surface of the lithium transition metal oxide particles. The Nb₂O₅ content of the positive-electrode active material thus produced was 1.0 mol %.

The test cell thus assembled is hereinafter referred to as a cell Z3.

### Comparative Example 4

A test cell was assembled in the same manner as in Example 1 except that tungsten trioxide was substituted by titanium oxide (TiO₂) and the positive-electrode active material contained TiO₂ attached to part of the surface of the lithium transition metal oxide particles. The TiO₂ content of the positive-electrode active material thus produced was 1.0 mol %.

The test cell thus assembled is hereinafter referred to as a cell Z4.

### Comparative Example 5

A test cell was assembled in the same manner as in Example 5 except that tungsten trioxide was not attached to part of the surface of the lithium transition metal oxide particles (thus, the positive-electrode active material was composed of the lithium transition metal oxide particles alone).

The test cell thus assembled is hereinafter referred to as a cell Z5.

### Comparative Example 6

A test cell was assembled in the same manner as in Example 6 except that tungsten trioxide was not attached to part of the surface of the lithium transition metal oxide particles (thus, the positive-electrode active material was composed of the lithium transition metal oxide particles alone).

The test cell thus assembled is hereinafter referred to as a cell Z6.

### Comparative Example 7

A test cell was assembled in the same manner as in Example 7 except that tungsten trioxide was not attached to part of the surface of the lithium transition metal oxide particles (thus, the positive-electrode active material was composed of the lithium transition metal oxide particles alone).

The test cell thus assembled is hereinafter referred to as a cell Z7.

### Comparative Example 8

A test cell was assembled in the same manner as in the Comparative Example 7 except that the lithium transition metal oxide particles of Li_{1.06}Ni_{0.56}Mn_{0.38}O₂ and niobium pentoxide (Nb₂O₅) having an average particle size of 150 nm were mixed to yield a positive-electrode active material containing Nb₂O₅ attached to part of the surface of the lithium transition metal oxide particles. The Nb₂O₅ content of the positive-electrode active material thus produced was 1.0 mol %.

The test cell thus assembled is hereinafter referred to as a cell Z8.

### Comparative Example 9

A test cell was assembled in the same manner as in Comparative Example 1 except that lithium transition metal oxide particles of LiCoO₂ were directly used as the positive-electrode active material. The lithium transition metal oxide had a volume-average primary particle size of approximately 2 μm and a volume-average secondary particle size of approximately 8 μm.

The test cell thus assembled is hereinafter referred to as a cell Z9.

### Comparative Example 10

A test cell was assembled in the same manner as in Comparative Example 9 except that the lithium transition metal oxide particles of LiCoO₂ and tungsten trioxide (WO₃) having an average particle size of 150 nm were mixed to yield a positive-electrode active material containing WO₃ attached to part of the surface of the lithium transition metal oxide particles. The WO₃ content of the positive-electrode active material thus produced was 1.0 mol %.

The test cell thus assembled is hereinafter referred to as a cell Z10.

### Comparative Example 11

A test cell was assembled in the same manner as in Comparative Example 1 except that lithium transition metal oxide particles of LiFePO₄ were directly used as the positive-electrode active material. The lithium transition metal oxide had a volume-average primary particle size of approximately 2 μm and a volume-average secondary particle size of approximately 8 μm.

The test cell thus assembled is hereinafter referred to as a cell Z11.

### Comparative Example 12

A test cell was assembled in the same manner as in Comparative Example 11 except that the lithium transition metal oxide particles of LiFePO₄ and tungsten trioxide (WO₃) having an average particle size of 150 nm were mixed to yield a positive-electrode active material containing WO₃ attached to part of the surface of the lithium transition metal oxide particles. The WO₃ content of the positive-electrode active material thus produced was 1.0 mol %.

The test cell thus assembled is hereinafter referred to as a cell Z12.

### Comparative Example 13

A test cell was assembled in the same manner as in Comparative Example 1 except that lithium transition metal oxide particles of LiMn₂O₄ were directly used as the positive-electrode active material. The lithium transition metal oxide had a volume-average primary particle size of approximately 2 μm and a volume-average secondary particle size of approximately 17 μm.

The test cell thus assembled is hereinafter referred to as a cell Z13.

### Comparative Example 14

A test cell was assembled in the same manner as in Comparative Example 13 except that the lithium transition metal oxide particles of LiMn₂O₄ and tungsten trioxide (WO₃) having an average particle size of 150 nm were mixed to yield a positive-electrode active material containing WO₃ attached to part of the surface of the lithium transition metal oxide particles. The WO₃ content of the positive-electrode active material thus produced was 1.0 mol %.

The test cell thus assembled is hereinafter referred to as a cell Z14.

### Comparative Example 15

A test cell was assembled in the same manner as in Example 8 except that tungsten trioxide was not attached to part of the surface of the lithium transition metal oxide particles (thus, the positive-electrode active material was composed of the lithium transition metal oxide particles alone).

The test cell thus assembled is hereinafter referred to as a cell Z15.

### (Experiment)

At a temperature of 25° C., the cells A1 to A9, Z1 to Z10, and Z15 were charged to 4.3 V (vs. Li/Li⁺) at a constant current at an electric current density of 0.2 mA/cm² and were charged to an electric current density of 0.04 mA/cm² at a constant voltage of 4.3 V (vs. Li/Li⁺), and were then discharged to 2.5 V (vs. Li/Li⁺) at a constant current at an electric current density of 0.2 mA/cm². The discharge capacity in the discharging was considered to be the rated capacity of each of the three-electrode test cells. The rated capacities of the cells Z11 and Z12 were determined in the same manner as described above except that the charging voltage was 4.0 V (vs. Li/Li⁺), and the discharge voltage was 2.0 V (vs. Li/Li⁺). The rated capacities of the cells Z13 and Z14 were determined in the same manner as described above except that the discharge voltage was 3.0 V (vs. Li/Li⁺).

Each of the cells A1 to A9 and Z1 to Z15 was charged to 50% of its rated capacity [state of charge (SOC) of 50%] at an electric current density of 0.2 mA/cm². Each of the cells A1 to A9 and Z1 to Z15 was then discharged at a temperature of 25° C. and −30° C. Table 1 shows the output results.

The outputs of the cells A1 to A4, A9, and Z1 to Z4 in Table 1 are based on the output of the cell Z1 at SOC of 50% at each temperature, which is taken as 100. The outputs of the cells A5 and Z5 in Table 1 are based on the output of the cell Z5 at SOC of 50% at each temperature, which is taken as 100. The outputs of the cells A6 and Z6 are based on the output of the cell Z6 at SOC of 50% at each temperature, which is taken as 100. The outputs of the cells A7, Z7, and Z8 are based on the output of the cell Z7 at SOC of 50% at each temperature, which is taken as 100. The outputs of the cells A8 and Z15 are based on the output of the cell Z15 at SOC of 50% at each temperature, which is taken as 100. The outputs of the cells Z9 and Z10 are based on the output of the cell Z9 at SOC of 50% at each temperature, which is taken as 100. The outputs of the cells Z11 and Z12 are based on the output of the cell Z11 at SOC of 50% at each temperature, which is taken as 100. The outputs of the cells Z13 and Z14 are based on the output of the cell Z13 at SOC of 50% at each temperature, which is taken as 100.

TABLE 1

| | Positive-electrode active material | | | | | | |
|---|---|---|---|---|---|---|---|
| | | Attached compound | | | | Output | |
| | | | | | Firing | characteristics | |
| | | | Amount | | temperature | at SOC 50% | |
| Cell | Lithium transition metal oxide | Type | (mol %) | Firing | (° C.) | 25° C. | −30° C. |
| A1 | Li_{1.07}Ni_{0.46}Co_{0.19}Mn_{0.28}O₂ | WO₃ | 1.0 | No | — | 116 | 164 |
| A2 | | WO₂ | 1.0 | No | — | 108 | 153 |
| A3 | | Li₂WO₄ | 1.0 | No | — | 114 | 188 |
| A4 | | WO₃ | 0.1 | No | — | 124 | 111 |
| A9 | | MO₃ | 1.0 | No | — | 108 | 144 |
| Z1 | | — | — | No | — | 100 | 100 |
| Z2 | | WO₃ | 1.0 | Yes | 700 | 87 | 102 |
| Z3 | | Nb₂O₅ | 1.0 | No | — | 93 | 93 |
| Z4 | | TiO₂ | 1.0 | No | — | 96 | 98 |
| A5 | Li_{1.07}Ni_{0.53}Co_{0.09}Mn_{0.31}O₂ | WO₃ | 1.0 | No | — | 111 | 123 |
| Z5 | | — | — | No | — | 100 | 100 |
| A6 | Li_{1.04}Ni_{0.48}Co_{0.19}Mn_{0.29}O₂ | WO₃ | 10.0 | No | — | 121 | 122 |
| Z6 | | — | — | No | — | 100 | 100 |
| A7 | Li_{1.06}Ni_{0.56}Mn_{0.38}O₂ | WO₃ | 1.0 | No | — | 108 | 110 |
| Z7 | | — | — | No | — | 100 | 100 |
| Z8 | | Nb₂O₅ | 1.0 | No | — | 96 | 104 |
| A8 | Li_{1.02}Ni_{0.8}Co_{0.15}Al_{0.03}O₂ | WO₃ | 1.0 | No | — | 111 | 113 |
| Z15 | | — | — | No | — | 100 | 100 |
| Z9 | LiCoO₂ | — | — | No | — | 100 | 100 |
| Z10 | | WO₃ | 1.0 | No | — | 95 | 92 |
| Z11 | LiFePO₄ | — | — | No | — | 100 | 100 |
| Z12 | | WO₃ | 1.0 | No | — | 85 | 95 |
| Z13 | LiMn₂O₄ | — | — | No | — | 100 | 100 |
| Z14 | | WO₃ | 1.0 | No | — | 96 | 100 |

As is clear from Table 1, the output characteristics at 25° C. and −30° C. of the cells A1 to A4, which contained the positive-electrode active material containing WO₃, WO₂, or Li₂WO₄ attached to part of the surface of the lithium transition metal oxide Li_{1.07}Ni_{0.46}Co_{0.19}Mn_{0.28}O₂ having a layer structure, were significantly improved as compared with the output characteristics of the cell Z1, which contained the positive-electrode active material containing the same lithium transition metal oxide as the cells A1 to A4 but not containing the tungsten compound, such as WO₃, attached to part of the surface. In particular, the output characteristics at −30° C. were dramatically improved. The output characteristics at 25° C. and −30° C. of the cell A9, which also contained the positive-electrode active material containing MoO₃ attached to part of the surface of the lithium transition metal oxide, were improved as compared with the cell Z1. In particular, the output characteristics at −30° C. were dramatically improved.

The output characteristics at 25° C. and −30° C. of the cells Z3 and Z4, which contained the positive-electrode active material containing the same lithium transition metal oxide as the cells A1 to A4 and containing Nb₂O₅ or TiO₂ attached to part of the surface of the lithium transition metal oxide, were inferior to the output characteristics of the cell Z1. Thus, in order to improve the output characteristics, the substance to be attached to part of the surface of the lithium transition metal oxide should be a tungsten compound, such as WO₃, and/or a molybdenum compound, such as MO₃.

Although the reason for the improved outputs due to the attachment of the tungsten compound and/or the molybdenum compound is not clear in detail, this is probably because the tungsten compound and/or the molybdenum compound reacts with residual lithium (a resistance component) disposed on the surface of the lithium transition metal oxide and thereby reduces the reaction resistance on the surface of the lithium transition metal oxide, and this promotes the charge transfer reaction at the interface between the lithium transition metal oxide and the electrolyte solution. On the other hand, the niobium compound (Nb₂O₅) and the titanium compound (TiO₂) probably do not react with residual lithium on the surface of the lithium transition metal oxide and could not reduce the amount of resistance component.

Comparison of the cells A1 to A3 shows that the cells A1 and A3, which contained the hexavalent tungsten compounds (WO₃ and Li₂WO₄), have the effect of improving the output characteristics greater than that of the cell A2, which contained the tetravalent tungsten compound (WO₂). Although the reason for this is not clear in detail, this is probably because the hexavalent tungsten compounds have higher reactivity to residual lithium than the tetravalent tungsten compound.

Comparison of the cells A1 and A3, both of which contained one of the hexavalent tungsten compounds, shows that the effect of improving the output characteristics at −30° C. of the cell A3, which contained the tungsten compound Li₂WO₄ containing lithium in its structure, is greater than that of the cell A1, which contained the tungsten compound WO₃ free of lithium in its structure. Although the reason for this is not clear in detail, this is probably because, in addition to the effect described above, lithium in the structure has an effect on the modification of the interface between the lithium transition metal oxide and the nonaqueous electrolyte solution and further reduces the charge transfer resistance.

Comparison of the cell A1, which contained WO₃ attached to the positive-electrode active material, with the cell A9, which contained MoO₃ attached to the positive-electrode active material, shows that the effect of improving the output characteristics of the cell A1 is greater than that of the cell A9. Although the reason for this is not clear in detail, this is probably because WO₃ has higher reactivity to residual lithium than MoO₃ and more effectively reduces the reaction resistance on the surface of the lithium transition metal oxide. Thus, a compound to be attached to part of the surface of the lithium transition metal oxide is more preferably a tungsten compound.

The cell Z2, which contained the positive-electrode active material produced by mixing WO₃ with the same lithium transition metal oxide as the cells A1 to A4 and firing the mixture at 700° C. for one hour, had the output characteristics comparable to or inferior to the output characteristics of the cell Z1. Although the reason for this is not clear in detail, this is probably because although the mixing with WO₃ reduces the amount of resistance component high-temperature firing after the mixing with WO₃ reproduces the resistance component on the surface of the lithium transition metal oxide, thus resulting in no reduction in charge transfer resistance.

The output characteristics at 25° C. and −30° C. of the cells A5 and A7, which contained the positive-electrode active material containing WO₃ attached to part of the surface of the lithium transition metal oxide of Li_{1.07}Ni_{0.53}Co_{0.09}Mn_{0.31}O₂ or Li_{1.07}Ni_{0.56}Mn_{0.37}O₂, are superior to the output characteristics of the cells Z5 and Z7, which contained the positive-electrode active material containing the same lithium transition metal oxide as the cells A5 and A7 but not containing WO₃ attached to part of the surface of the lithium transition metal oxide. Thus, lithium transition metal oxides containing little or no cobalt also have the advantages of the present invention.

The output characteristics at 25° C. and −30° C. of the cell A8, which contained the positive-electrode active material containing WO₃ attached to part of the surface of the lithium transition metal oxide of the lithium transition metal oxide of Li_{1.02}Ni_{0.8}Co_{0.15}Al_{0.03}O₂, are superior to the output characteristics of the cell Z15, which contained the positive-electrode active material containing the same lithium transition metal oxide as the cell A8 but not containing WO₃ attached to part of the surface of the lithium transition metal oxide. Thus, lithium transition metal oxides free of manganese also have the advantages of the present invention.

The effect of improving the output characteristics due to the attachment of WO₃ is greater in the cells A1 and A5, which contained all of nickel, manganese, and cobalt as transition metals of the lithium transition metal oxide, than in the cell A7, which contained no cobalt as a transition metal, and the cell A8, which contained no manganese as a transition metal. Thus, the transition metal of the lithium transition metal oxide preferably contains all of nickel, manganese, and cobalt.

The output characteristics of the cell Z8, which contained the positive-electrode active material containing Nb₂O₅ attached to part of the surface of the lithium transition metal oxide of Li_{1.06}Ni_{0.56}Mn_{0.38}O₂, are comparable to and are not improved as compared with the cell Z7, which contained the positive-electrode active material containing the same lithium transition metal oxide as the cell Z8 but not containing Nb₂O₅ attached to part of the surface of the lithium transition metal oxide. As in the cell Z3, this is probably because the niobium compound (Nb₂O₅) does not react with residual lithium on the surface of the lithium transition metal oxide and could not reduce the amount of resistance component.

The output characteristics at 25° C. and −30° C. of the cells Z10, Z12, and Z14, which contained the positive-electrode active material containing WO₃ attached to part of the surface of the lithium transition metal oxide of LiCoO₂, LiFePO₄, or LiMn₂O₄, are inferior to the output characteristics of the cells Z9, Z11, and Z13, which contained the positive-electrode active material containing the same lithium transition metal oxide as the cells Z10, Z12, and Z14 but not containing WO₃ attached to part of the surface of the lithium transition metal oxide. Thus, the cells Z10, Z12, and Z14 could not produce the effect of improving the output characteristics. Although the reason for this is not clear in detail, this is probably because the lithium transition metal oxide of LiCoO₂, LiFePO₄, or LiMn₂O₄ has little residual lithium on its surface, and WO₃ attached to part of the surface of the lithium transition metal oxide cannot produce its effect.

The amount of tungsten compound, such as WO₃, to be added will be described below.

The output characteristics at 25° C. and −30° C. of the cell A4, which contained the positive-electrode active material containing 0.1 mol % WO₃ attached to part of the surface of the lithium transition metal oxide of Li_{1.07}Ni_{0.46}Co_{0.19}Mn_{0.28}O₂, are superior to the output characteristics of the cell Z1, which contained the positive-electrode active material containing the same lithium transition metal oxide as the cell A4 but not containing WO₃ attached to part of the surface of the lithium transition metal oxide. The output characteristics at 25° C. and −30° C. of the cell A6, which contained the positive-electrode active material containing 10 mol % WO₃ attached to part of the surface of the lithium transition metal oxide of Li_{1.04}Ni_{0.48}Co_{0.19}Mn_{0.29}O₂, are superior to the output characteristics of the cell Z6, which contained the positive-electrode active material containing the same lithium transition metal oxide as the cell A6 but not containing WO₃ attached to part of the surface of the lithium transition metal oxide. This shows that the output characteristics can be sufficiently improved when the amount of WO₃ attached to part of the surface of the lithium transition metal oxide ranges from 0.1 to 10 mol %.

### REFERENCE SIGNS LIST

10 three-electrode test cell
11 working electrode (positive electrode)
12 counter electrode (negative electrode)
13 reference electrode
14 nonaqueous electrolyte solution

1. A nonaqueous electrolyte secondary battery, comprising:
a positive electrode containing a positive-electrode active material, the positive-electrode active material containing a lithium transition metal oxide and a tungsten compound and/or a molybdenum compound attached to part of the surface of the lithium transition metal oxide, the lithium transition metal oxide containing nickel as a main component of the transition metal;
a negative electrode containing a negative-electrode active material;
a separator disposed between the positive electrode and the negative electrode; and
a nonaqueous electrolyte solution with which the separator is impregnated.

2. The nonaqueous electrolyte secondary battery according to claim 1, wherein the transition metal of the lithium transition metal oxide contains manganese and/or cobalt in addition to nickel.

3. The nonaqueous electrolyte secondary battery according to claim 2, wherein the transition metal of the lithium transition metal oxide contains manganese and cobalt in addition to nickel.

4. The nonaqueous electrolyte secondary battery according to claim 3, wherein the lithium transition metal oxide is an oxide having the general formula Liᵢ₊ₓNiₐMn_{b}Co_{c}O_{2+d} (wherein x, a, b, c, and d satisfy x+a+b+c=1, 0<x≦0.1, a≧b, a≧c, 0<c/(a+b)<0.65, 1.0≦a/b≦3.0, and −0.1≦d≦0.1).

5. The nonaqueous electrolyte secondary battery according to claim 1, wherein the tungsten compound is a tungsten-containing oxide, and the molybdenum compound is a molybdenum-containing oxide.

6. The nonaqueous electrolyte secondary battery according to claim 1, wherein the lithium transition metal oxide has a volume-average primary particle size of 0.5 μm or more and 2 μm or less and a volume-average secondary particle size of 3 μm or more and 20 μm or less.

7. The nonaqueous electrolyte secondary battery according to claim 2, wherein the tungsten compound is a tungsten-containing oxide, and the molybdenum compound is a molybdenum-containing oxide.

8. The nonaqueous electrolyte secondary battery according to claim 3, wherein the tungsten compound is a tungsten-containing oxide, and the molybdenum compound is a molybdenum-containing oxide.

9. The nonaqueous electrolyte secondary battery according to claim 4, wherein the tungsten compound is a tungsten-containing oxide, and the molybdenum compound is a molybdenum-containing oxide.

10. The nonaqueous electrolyte secondary battery according to claim 2, wherein the lithium transition metal oxide has a volume-average primary particle size of 0.5 μm or more and 2 μm or less and a volume-average secondary particle size of 3 μm or more and 20 μm or less.

11. The nonaqueous electrolyte secondary battery according to claim 3, wherein the lithium transition metal oxide has a volume-average primary particle size of 0.5 μm or more and 2 μm or less and a volume-average secondary particle size of 3 μm or more and 20 μm or less.

12. The nonaqueous electrolyte secondary battery according to claim 4, wherein the lithium transition metal oxide has a volume-average primary particle size of 0.5 μm or more and 2 μm or less and a volume-average secondary particle size of 3 μm or more and 20 μm or less.

13. The nonaqueous electrolyte secondary battery according to claim 5, wherein the lithium transition metal oxide has a volume-average primary particle size of 0.5 μm or more and 2 μm or less and a volume-average secondary particle size of 3 μm or more and 20 μm or less.
